(19) United States
(12) Patent Application Publication
(10) Pub. No.: US 2012/0077137 A1
(43) Pub. Date: Mar. 29, 2012

(54) JOINING ARRANGEMENT FOR JOINING A FIRST JOINING PARTNER TO A SECOND JOINING PARTNER OF A VEHICLE

(75) Inventors: Ralf Schmidt, Oelde (DE); Guido Opperbeck, Lippstadt (DE)

(73) Assignee: HBPO GmbH, Lippstadt (DE)

(21) Appl. No.: 13/319,321

(22) PCT Filed: Feb. 3, 2010
(86) PCT No.: PCT/EP10/51325

§ 371 Date: Dec. 6, 2011

(30) Foreign Application Priority Data
May 5, 2009 (DE) 10 2009 019 730.3

(51) Int. Cl. F24J 3/00; B60R 99/00

(52) U.S. Cl. 432/225; 24/304

(57) ABSTRACT

The invention relates to a joining assembly for joining partners of a vehicle, including a first joining partner, at least one second joining partner, and a holding device by which the joining partners can be connected to each other to form the joining assembly, where the holding device includes a receiving structure on which at least one adhesive member is arranged, which can be brought into at least two states, where in a first state, the adhesive member allows an adjustment of the second joining partner on the first joining partner, where the change from the first state into a second state can be activated by transformation means, where in the second state, the adhesive member is cured, whereby fixation of the joining partners to each other can be achieved.

### TECHNICAL FIELD

The invention involves a joining arrangement to join joining partners of a vehicle comprising a first joining partner and at least one second joining partner, wherein a holding device is intended that serves for connecting the joining partners in order to form a joining arrangement. Further the invention involves a method to join joining partner of a vehicle comprising a first joining partner and at least a second joining partner whereby a holding device is intended to join the joining partners in order to build a joining arrangement.

### BACKGROUND

A front module of vehicles bearing an assembly carrier being mounted to the carriage of the vehicle is know from DE 10 2007 016 925 A1. Further an illumination device is arranged at an assembly carrier, whereas the mounting of the illumination device occurs via a holding device, in particular via a holding base. Therewith the assembly carrier is providing the first joining partner and the illumination device is providing the second joining partner. The holding base, forming the holding device, can be placed between a preliminary assembly position and a final assembly position. In order to adjusting existing tolerances during the assembly of the assembly carrier at the vehicle, an according adjustment of the illumination device at the assembly carrier is required. After the illumination device of the vehicle has been adjusted for the given contouring to the neighboring carriage, a final fixation of the illumination device occurs using fixing means, in particular a screwed assembly, whereby a substantial complexity of assembling, in particular a significant complexity of adjustment, arises.

### BRIEF SUMMARY

The invention accomplishes a joining arrangement to join joining partners of a vehicle, with a reduced complexity of assembling, in particular a reduced complexity of adjusting two joining partners of a vehicle to one another.

According to the invention it is intended that the holding device bears a receiving composition comprising at least one adhesive element which is at least convertible into two different states. In the first state the adhesive element enables an adjustment of the second joining partner to the first joining partner, whereby an exchange from the first to the second state can be activated by a means. In the second state however the adhesive element is cured whereby a fixation of the joining partners to one another can be achieved.

The basic of the invention comprises joining partners which are attached to one another or attached to a vehicle, whereas simultaneously it is ensured that the joining partners comprise a specified contouring relative to one another or particularly relative to a vehicle and therewith relative to the neighboring carriage of a vehicle. Due to the adhesive element being arranged at the receiving composition and allowing an adjustment of at least one joining partner in its first state, a reliable and safe positioning of the joining partner at the vehicle or the joining partners among one another is ensured. In the first state of the adhesive element the receiving composition is in its preliminary assembly position in which the joining partner can be aligned according to the neighboring carriage of the vehicle, e.g. the car wing or the bonnet, etc. Has a corresponding arrangement of the illumination device taken place by the workman the transformation from the first to the second state is activated via means. Due to this transformation the adhesive element is curing. By this the receiving composition has already reached its final position. In the cured state of the adhesive element, meaning if the adhesive element has reached its second state, one joining partner at the vehicle has reached its final position corresponding to the reference position. Hence, a final fixation of the joining partner is achieved in a simple way.

It may be useful if the means are accomplished as external means. The external means can be carried out as energy, which activates the modification from the first to the second state based on a variation of the environmental condition. This may occur e.g. through access of light, sound, humidity or exclusion from atmospheric oxygen. The external means may be composed of chemical means, in particular fluids, and/or electrical means and/or mechanical means and/or airborne contact and/or means in terms of energy supply, in particular thermal energy to raise the temperature of the adhesive element, brought in preferably from external heat transmission and/or from electromagnetic radiation, especially energy from light, and/or from sound energy, especially from ultrasonic sound, and/or from microwaves and/or from induction. Adhesives being transferred from a first to a second state through the insertion of energy are basically known. If energy is inserted into the mass of the adhesive a curing of the adhesive may occur and both joining partners are fixed to one another.

A possible transformation of an adhesive from its second back to its first state using the same or different means, in particular external means, is particularly known and can be used advantageously. It is e.g. possible that after a fixation of the joining partners to one another a state of the adhesive can be achieved in which both joining partners can be readjusted.

It is in particular advantageously that the modification from the first to the second state occurs within a range of minimal effort. Is the first joining partner already in its desired adjusting position, there is no further need for a workman to fix the illumination device to the assembly carrier via e.g. mechanical fixing means, like bolts etc. The adhesive element solely needs to achieve its second state, whereas the adhesive element is nearly cured in the second state and therefore the final fixation of the illumination device at the assembly carrier is assured.

Following a preferred embodiment of the front module the holding device is assembled at the assembly carrier and/or at the illumination device. Advantageously the receiving position comprises multiple parts whereby a first receiving composition is assembled at the assembly carrier and a second receiving composition at the illumination device. In order to ensure an exceptional compact assembly the adhesive element is adapted to the geometry of the receiving composition advantageously. Is the font module integrated in the vehicle the receiving composition of multiple parts, also containing the adhesive element, an especially reliable and simple adjustment of the illumination device is promoted until a transformation into the second state of the adhesive element occurs, out of the final position of the receiving composition, in which the illumination device is joint in the first state of the adhesive element. The receiving composition is particularly forming a cavity in which the adhesive element, adapted to the cavity, is adjusted whereby the adhesive element is preferably viscous in its first state.

According to another advantage the adhesive element can be composed of Hotmelt, in particular a reactive Hotmelt, and/or of encapsulated polyurethan and/or of epoxide adhesive and/or of acrylate adhesive. In particular the receiving composition may be of multi parts, whereas at least a first part of the receiving composition is arranged at the first joining partner and a second part of the receiving composition is arranged at the second joining partner and/or is integrally formed and/or is composed of itself, respectively.

According to an advancement of the invention the first receiving composition is formed as an opening and/or the second receiving composition is formed as a rod-shaped element whereby in particular the opening is receiving the preferably cylindrically shaped adhesive element and/or the adhesive element is enclosing the rod-shaped element so as the rod-shaped element is extending itself in the opening. The adhesive element can be shaped as a cylindrical body which is assembled accordingly in the opening of the first receiving position. Further geometric forms are conceivable as well, meaning that the opening and the rod-shaped element instead of a circular transversal section can be shaped in a e.g. squared, quadratic etc. manner as well. The adhesive element is adapted to the according geometry of the opening as well as to the rod-shaped element of the receiving position.

With another advantage the second receiving composition is in a T-like shape, whereby the rod-shaped element possess two opposing ends having a first receiving composition assembled at both ends respectively and whereby the holding device is preferably assembled to the assembly carrier by form- and/or force-closure and whereby the rod-shaped element particularly solely possess an idle end at one side at which the first receiving composition is adjustable. Additionally, it is conceivable that the first receiving composition and/or the second receiving composition are forming a common component part together with the assembly carrier and/or the illumination device.

The first receiving structure as well as the second receiving structure are constructionally formed in a way that the translational and the rotatory movement of the joining partners towards their draw-edges or the draw-edges at the neighboring carriage parts of the vehicle are possible. Herewith the adhesive element can be viscous in its first state. The adhesive element is malleably deformable during adjustment of e.g. the illumination device in its first state. If the desired final mounting position, after adjusting the illumination device, is reached a subsequent activation of the transformation of states of the adhesive member occurs. Due to the high assembly allowances the viscous adhesive element promotes clean jointings to the adjacent carriage parts like the car wing, the outer edge of the bumper, the bonnet, etc. using an accordant adjustment of the illumination device.

Likewise it is conceivable to transform the adhesive element into its second state via internal means. At this the adhesive element can possess at least two chambers or both chambers build one cavity, whereas in the first chamber a first component of the adhesive and in the second chamber a second component of the adhesive resides. Advantageously, a barrier element is intended which separates the chambers in the inactivated state of the adhesive element and upon activation the wall element is flexible enabling the mixing of the first and the second component of the adhesive, whereas the wall element is flexibly mounted in particular to the adhesive element and can be activated from the outside using a defined zone of engagement. The wall element may e.g. be flexibly mounted to the adhesive element and may be turned into its operative position using a defined external area. Advantageously, both components comprise monomers defining the basic molecules of the polymer developing during the mixture. One of both components can e.g. comprise resin monomers or so-called binding agents, while the other component comprises a curing agent. Further ingredients of the components may be stabilizers, thixotropic agents, mediators, further additives and/or dyes or filler media. The barrier element may be a membrane, which admits a mixture of both components after the final assembly.

With a notable advantage the joining arrangement is formed for joining preventilated assembly groups of a vehicle, in particular of a front module, of a rear end module, of a hatch door, of a door module and/or of a bumper, in particular a cover of a bumper at a carriage of a vehicle, an illumination device with or at an assembly carrier and/or a cockpit device of a vehicle. According to the present invention, the joining arrangement for joining preventilated assembly groups of a vehicle is basically advantageously applicable if the assembly group comprises components which need an exact arrangement to one another or the assembly group needs an exact arrangement towards the carriage structure of the vehicle to e.g. maintain clearances. If an illumination device in a front module, in particular a headlight, and if the front module is fixed to the carriage via the assembly carrier, the headlight maintains clearances with the carriage or other interfaces, which need to be kept exactly. A summation of dimensional tolerances develops from multiple sequent components mounted to one another, leading to the advantage of a possible adjustment of assembly groups using the holding device according to the present invention and the therein affiliated adhesive element without the necessity to manually reach the holding device and the adhesive element. A single adjustment position of the assembly groups may be “frozen up” if, according to the present invention, external means, e.g. induction coil units, are used to transform the adhesive element from its first to its second state. The external means activating the transformation of states of the adhesive element may be accomplished in a way that a workman does not need to arrange an adjustment position simultaneously to activate the transformation of states of the adhesive element. The external means may cover e.g. a time-dependent activation, an activation due to mechanic influence or the insertion of energy, whose activation may be regulated via an easy-to-operate control element, e.g. a foot-switch.

According to another advantageous embodiment the first receiving composition is formed as a casing and/or the second receiving composition is shaped as a cylinder element, whereby the cylinder element extends itself into the casing and whereby the adhesive element is preferably in shape of a hollow cylinder and is arranged between the casing and the cylinder element.

Advantageously, the casing is clipsable to the first joining partner via a clips connection, whereby the adhesive element is preferably arranged between the casing and the cylinder element in a way that the adhesive member is assembled in the casing preliminary to the establishment of the clips connection and is arranged in a loss-proofed way, in particular in the first state of the adhesive element, after the establishment of the clips connection in the casing.

According to another embodiment the first receiving composition is formed as a flange with a counter piece and/or the second receiving composition is formed as a mushroom-like inner section, whereas the counter piece comprises a half-shell like receiving area in which the mushroom-like inner section is incorporated.

Preferentially, one or multiple resting means are intended whereby the counter piece can be locked with the flange through resting means and whereby the adhesive element is incorporated in the half-shell like receiving area and whereby in particular a sealing element is intended which encloses the mushroom-like inner section within the range of the outlet port of the counter piece.

It is also conceivable that the first receiving composition is accomplished as a mounting clip extending in a mounting clip level, whereby the second receiving composition is preferably formed as a mounting sleeve which extends through the mounting clip along an axis of casing and which is preferably inserted into a connecting element, whereby in particular the axis of casing is representing a surface normal to the mounting clip level.

It is a particular advantage that the mounting clip is comprising an upper and a lower compartment of a clips, which are placed against one another to build a cavity, so that an adhesive element is receivable in the cavity, whereby moreover in the upper compartment of a clips and in the lower compartment of a clips a sealing element is received and whereby the mounting clip is applied particularly to the first joining partner.

According to another embodiment the first receiving composition is formed as a bowl-like body with a counter piece and/or the second receiving composition is formed as a cylindrical inner section which extends into the bowl-like body and whereby the adhesive element is assembled between the bowl-like body and the cylindrical inner section whereby the counter piece particularly comprises a sealing structure.

According to another embodiment a heating-element is intended, which is arranged at and/or in the adhesive element itself or at least at the cavity and which is accomplished to heat the adhesive element in a way that the heating-element builds a or the means to activate the transformation from the first to the second state of the adhesive element. Using the heating element heat can be transferred into the adhesive element activating a transformation from the first to the second state of the adhesive element. The heating element can be shaped as a resistance element which heats by applying a current and therewith by generating an electrical current flow. If the heating element is enclosed in the adhesive element or is adjoining to the heating element, by being incorporated into the cavity as well, a heat insertion into the adhesive element occurs by a heat transformation from the heating element to the adhesive element.

According to another embodiment the first joining partner is build as an assembly carrier member for an illumination device of a vehicle and that the second joining partner is accomplished as an illumination device of the vehicle, whereby the holding device comprises a receiving composition at which at least one adhesive element is assembled which is transformable into at least two states, whereby the first state the adhesive element enables an adjustment of the illumination device at the assembly carrier and via means the transformation from the first to the second state is activatable whereby the adhesive element is cured in its second state by what a fixation of the illumination device at the assembly carrier is achievable.

According to the invention a method to join joining partners of a vehicle containing a first joining partner and at least a second joining partner is intended, whereby a holding device is provided which is connecting the joining partners to build a joining arrangement. In particular the holding device is comprising a receiving composition at which at least one adhesive element is located which is transformable into at least two states whereby in a first state an arrangement of the first joining partner is conducted towards the second joining partner and via means a transformation from the first to the second state is activatable whereby in the second state the adhesive element is cured by what a fixation of the joining partners to one another is achieved.

In particular a method is intended to mount a front module at the carriage of a vehicle with an assembly carrier at which an illumination device is assembled above a holding device whereby the assembly carrier is mounted together with the illumination device to a structural part of the carriage. Herewith a holding device is comprising a receiving composition at which at least one adhesive element is assembled that is at least transformable into two states whereby in a first state of the adhesive element an adjustment of the illumination device at the carriage is possible and via means a transformation from the first to a second state is activated and a curing procedure of the adhesive element is started whereby the adhesive element is cured in the second state possibly leading to a fixation of the illumination device at the assembly carrier as well as at the carriage.

A particular advantage of the method according to the present invention is that the effort of assembling can be reduced. On the one hand an efficient adjustment of the illumination device in the first state of the adhesive element can be achieved. On the other hand a secured fixation of the illumination device at the assembly carrier as well as at the carriage is achievable by gaining the final adjustment position of the illumination device at the carriage of the vehicle after adjusting the illumination device. The final fixation occurs solely via means which initiate the transformation of the adhesive element from its first to ist second state.

The method according to the invention is suitable if the first joining partner is formed as an assembly carrier and the second joining partner is formed as a part of the carriage, whereby the assembly carrier is building the basic structure of a front module, a rear end module, a hatch door, a door module and/or of a bumper, in particular a cover of a bumper and/or a cockpit device and/or the second joining partner forms an illumination device assembled at the assembly carrier.

Advantageously, the means are assembled as external means. The external means can preferably be energy, in particular heat, light, in particular UV-radiation, sound and/or induction.

In an alternative embodiment of the invention the external means can be a fluid that is added after adjusting the illumination device to the adhesive element in particular via channels assembled at the holding device, at the assembly carrier and/or at the carriage.

Advantageously the transformation from the first to the second state of the adhesive element (curing procedure) takes less than 60 seconds, preferably less than 10 seconds.

According to a preferred embodiment of the method according to the invention a sucking device is intended to adjust the illumination device and/or during the transformation from the first to the second state of the adhesive element which contacts the illumination device. A workman can adjust the illumination device using the sucking device. Further the illumination device can be kept in its desired final mounting position during the curing procedure of the adhesive element via a positioning fixation of the sucking device or via another receiving composition.

Advantageously, the adhesive element is in its first state serving to adjust the illumination device as a form of a hinge means and in its second state as a pure fixation means for the illumination device.

The holding device can advantageously be formed in a way that a translational and a rotatory movement of the illumination device is possible in the first state of the adhesive element. The illumination device can comprise e.g. a separate daytime running light, a fog light or a headlight of a vehicle. For adjusting the illumination device is herewith movable into all directions whereby the adhesive element is advantageously compressed in its first state.

It is also conceivable that in the first state of the adhesive element a second receiving composition assembled at the illumination device has a way of moving for the adjustment relative to the first receiving composition assembled at the assembly carrier whereby the way of moving preferably accounts up to 3 mm, and more preferably up to 10 mm. Herewith existing fabrication tolerances can be reliably cleared.

### BRIEF DESCRIPTION OF THE DRAWINGS

Further advantages, characteristics and details of the invention are shown in the subsequent description, in which a potential illustrative embodiment of the invention is described in detail in reference to the drawings. It is shown:

FIG. 1 a perspective view of the joining arrangement using the example of the front module whereby a first joining partner is composed of an assembly carrier and the second joining partner of an illumination device, whereby the illumination device is not mounted to the assembly carrier,

FIG. 2 a perspective view of an execution example of a holding device possessing a first receiving composition shaped as an opening in which an adhesive element is assembled,

FIG. 3 a partial view of an illumination device assembled at the second receiving composition at which the first receiving composition of the assembly carrier is mounted,

FIG. 4 a partial view of the illumination device according to FIG. 1,

FIG. 5 another partial view of the illumination device according to FIG. 1,

FIG. 6 a lateral view of the illumination device according to FIG. 1,

FIG. 7 another perspective view of the illumination device, mounted to the assembly carrier,

FIG. 8 another perspective view of the illumination device, shown without an assembly carrier,

FIG. 9 a schematic lateral view of the first and second receiving composition,

FIG. 10 a, b a schematic view of another embodiment of an inserting adhesive element for the holding device,

FIG. 11 another embodiment of the holding device in which the first receiving composition is formed as a casing and the second receiving composition as a cylinder element,

FIG. 12a another embodiment of the holding device, in which the first receiving composition is formed as a flange with a counter piece and the second receiving composition is formed as a mushroom-shaped inner section,

FIG. 12b the embodiment of the holding device according to FIG. 12 in a non-mounted, perspective view,

FIG. 13 another embodiment of the holding device in a perspective view in which the first receiving composition is formed as a mounting clip and the second receiving composition is formed as a mounting sleeve,

FIG. 14 the embodiment according to FIG. 13 in a sliced, 2-dimensional view,

FIG. 15 the mounting clip according to the executive example of FIG. 13 in a perspective, flying view,

FIG. 16 another embodiment of the holding device in which the first receiving composition is formed as a bowl-like body and the second receiving composition is formed as a cylindrical inner section,

FIG. 17 embodiment of the holding device according to FIG. 16 in a non-mounted, perspective view,

### DETAILED DESCRIPTION

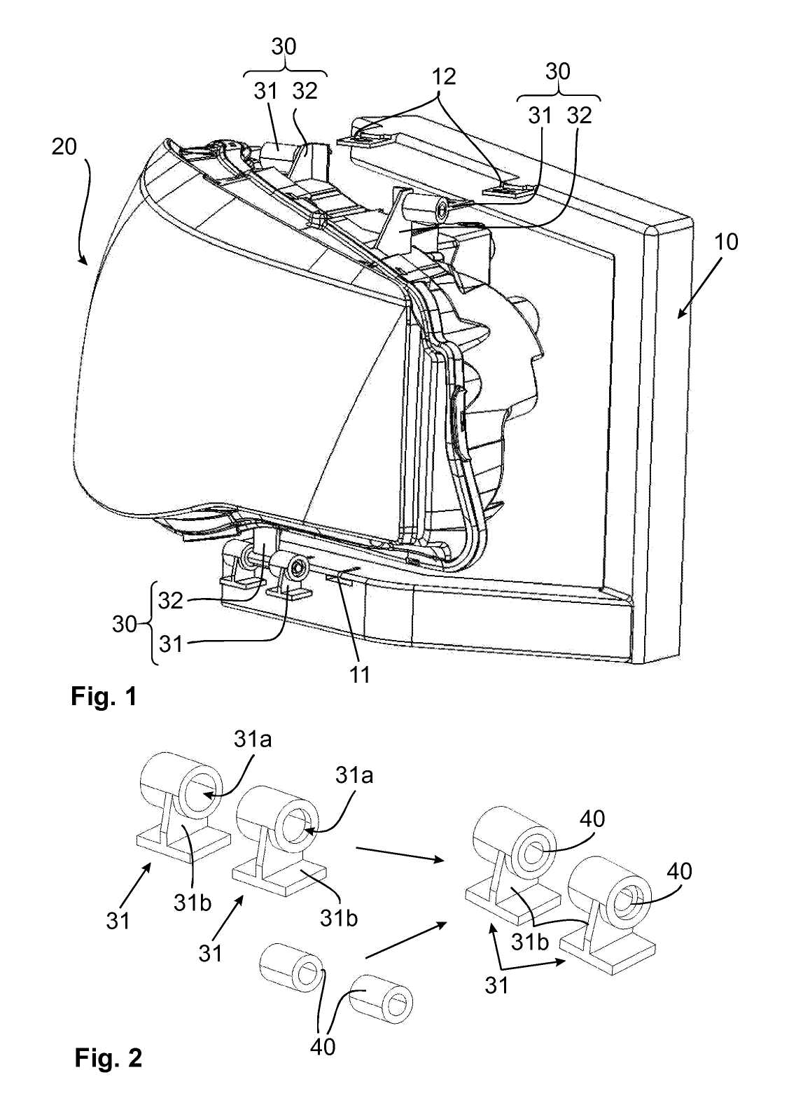

FIG. 1 is showing a perspective view of a joining arrangement using the example of a front module whereby a first joining partner 10 is build by an assembly carrier 10 and a second joining partner 20 by an illumination device 20. The shown embodiment of the holding device 30 is also suitable for different joining arrangements, the first joining partner 10 can e.g. be accomplished as an assembly carrier 10 and the second joining partner 20 as a part of the carriage of a vehicle whereby the assembly carrier 10 is building the basic structure of a front module, a rear end module, a hatch door, a door module and/or of a bumper, in particular a cover of a bumper.

A front module for vehicles substantially extends itself along the entire width of the vehicle and is mounted at its frontal area. The front module, not shown in its entirety according to FIG. 1, comprising an elongated assembly carrier 10 which is partly shown. The assembly carrier 10 comprises not only a receiving of e.g. a cooling aggregate and a bumper but also receivings for mounting illumination devices 20 at opposing edges of the receiving, respectively. According to the represented embodiment the illumination device 20 is formed as a headlight and comprises a casing which is assembled at the assembly carrier 10 via a holding device 30 which is shown according to the exposition of the first embodiment.

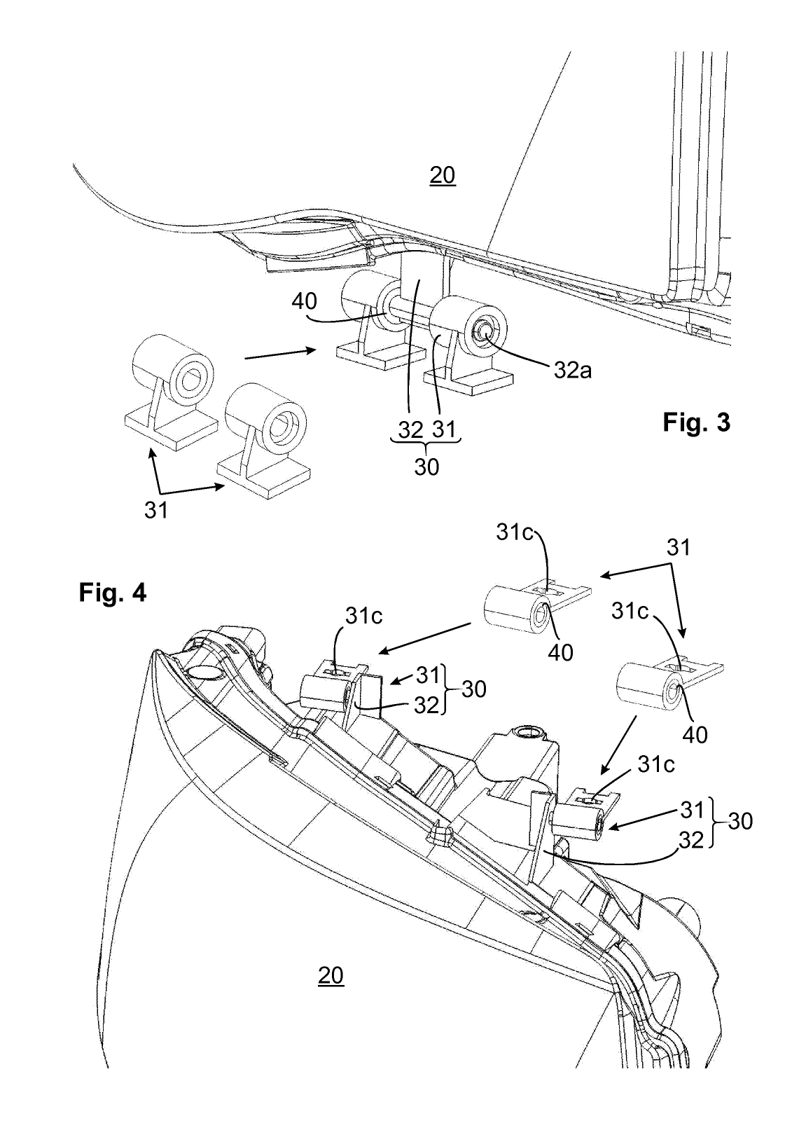

The receiving composition 31, 32 comprises multiple parts, like explicitly shown in FIGS. 1 and 3. According to this embodiment the receiving composition 31, 32 comprises a first receiving composition 31 attachable to the assembly carrier 10. The first receiving composition 31 comprises an opening 31a, explicitly shown in FIG. 2. An adhesive element 40, shown in the present embodiment as a cylindrical body, is insertable into the opening 31a. The second receiving composition 32 is formed in a T-like footing area 31b which is, according to FIG. 1, during the mounting of the illumination device 20 to the assembly carrier 10, inserted in a corresponding receiving opening 11 which is adapted to the footing area 31b. Various other mounting alternatives using form- and/or force-closure are conceivable as well.

Is the adhesive element 40 arranged within the opening 31a of the first receiving composition 31 the first receiving composition 31 is mounted to the second receiving composition 32 of the illumination device 20 together with the adhesive element 40 (FIG. 3). The second receiving composition 32 is formed as a rod-shaped element 32a in the illustrated embodiment. Herewith the second receiving composition 32 is in a T-like shape whereby the rod-shaped element 32a comprises two opposing edges and whereby both edges comprise the first receiving composition 31 respectively along with the particular adhesive element 40.

According to FIGS. 1 and 3 the illumination device 20 comprises a receiving composition 31, 32 in its lower part whereby the upper part of the illumination device 20 comprises two receiving compositions 31, 32 which are shown in FIG. 4 as follows.

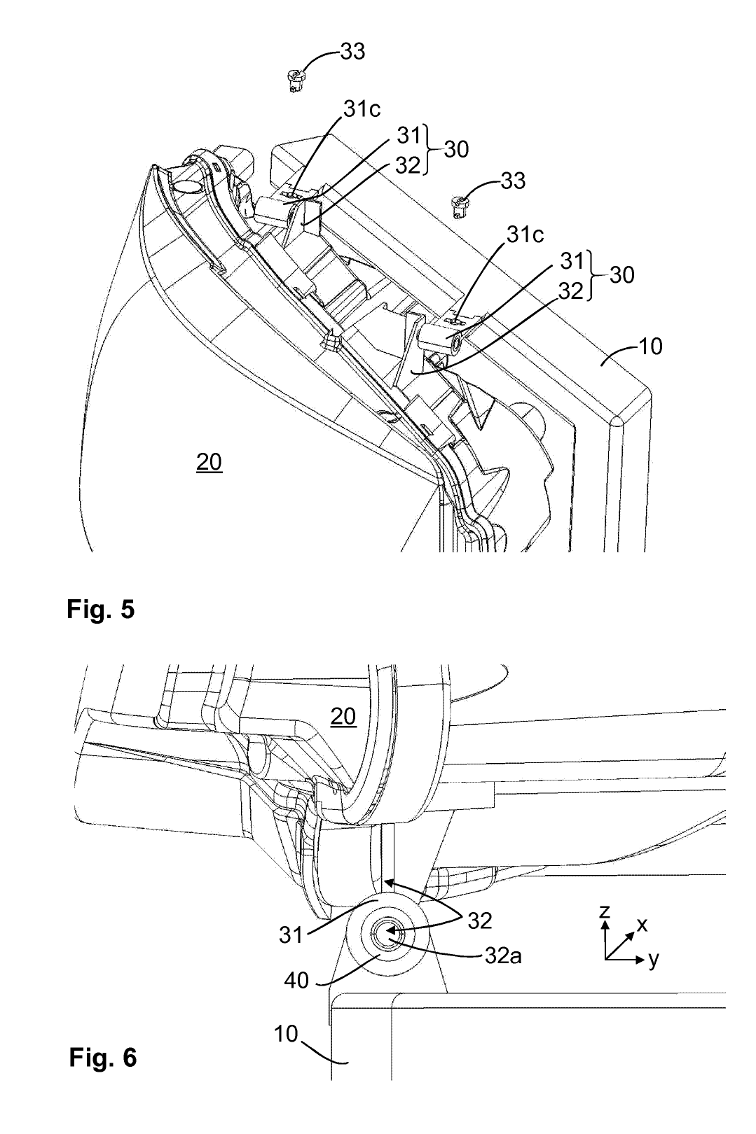

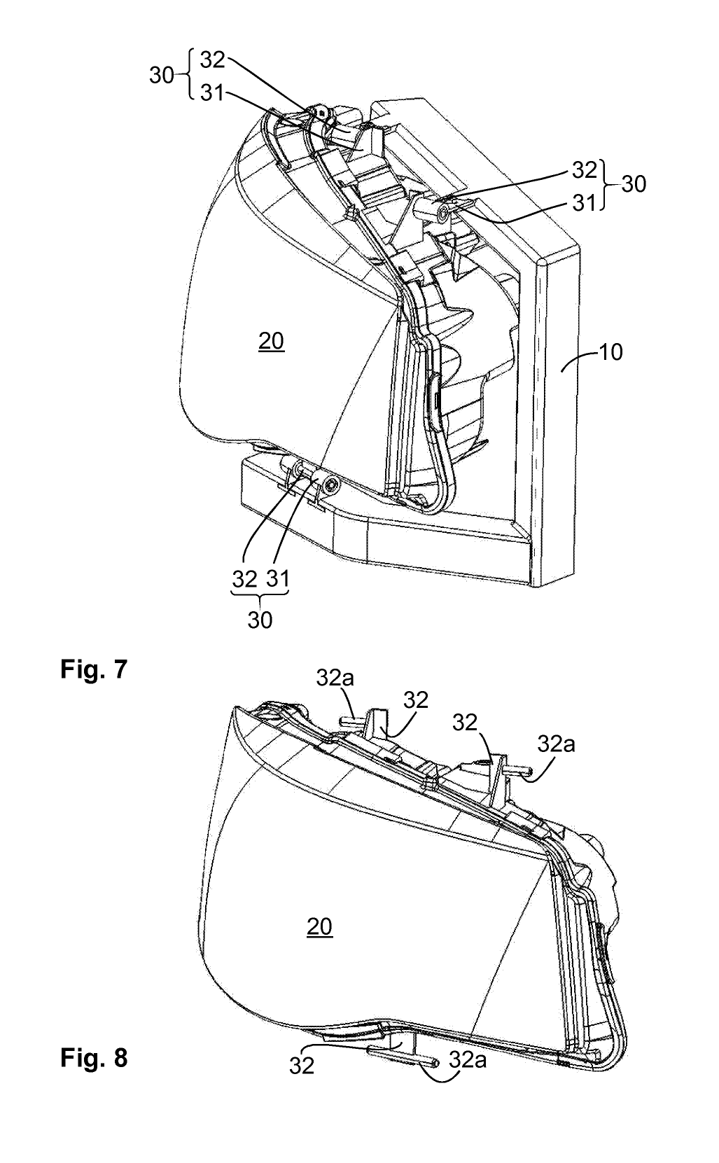

The first receiving composition 31 comprises an opening 31a in which the cylindrical adhesive element 40 is already inserted. The second receiving composition 32 comprises solely one free edge at which the first receiving composition 31 and the adhesive element 40 are mountable. Further the first receiving composition 31 comprises an opening 31c conducing to mount the receiving composition 31, 32 at the assembly carrier 10, schematically shown in FIG. 5. The assembly carrier 10 comprises an appropriate opening 12 as shown in FIG. 1. The attachment of the receiving composition 31, 32 of the upper part of the illumination device 20 at the assembly carrier 10 is practicable via a screw element 33, shown in FIG. 5, which is guided through the openings 12, 31c.

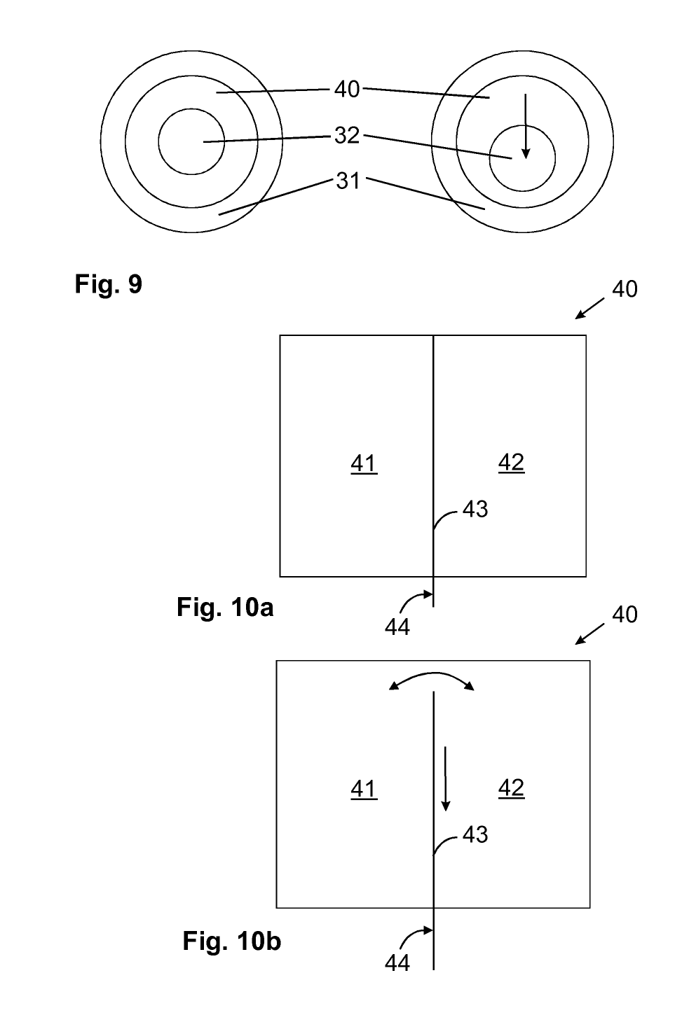

After the illumination device 20 is assembled according to the receiving composition 31, 32, which can occur e.g. via a notch connection or via supplementary fixation elements, the real adjustment of the illumination device 20 at the assembly carrier 10 or at adjacent parts of the carriage of the vehicle respectively, which are located directly at the illumination device 20, takes place. Herewith the adhesive element 40 is transformable into two states. In the first state an adjustment of the illumination device 20 can occur due to the existing fabrication tolerances. This is schematically indicated in FIGS. 6 and 9. The adjustment of the illumination device 20 can occur in all directions of movement which are indicated in the shown coordinate plane in FIG. 6. Herewith the adhesive element 20 can be sectionally compressed in its first state, indicated in FIG. 9. The second receiving composition 32 of the illumination device 20 can, for adjusting, accomplish a way of movement relative to the first receiving composition 31 of the assembly carrier 10 whereby the way of movement may conduct +/−3 mm in the present embodiment.

As the adjustment has reached its desired final assembly position a transformation of the adhesive element 40 from its first to its second state occurs via external means. During the transformation to the second state the adhesive element 40 is cured. In the present embodiment the external means is energy which is lead into the adhesive element 40 from the outside whereby a transformation from the first to the second state is activated. Herewith e.g. UV-light can be utilized. Heat and/or sound can be applied as energy means as well. This is depending on the used material of the adhesive element 40. The usage of a 2-component-adhesive is conceivable. A fluid, presenting the second component, is added to the adhesive element 40 after adjusting the illumination device 20. Subsequently the already described transformation into the second state of the adhesive element 40 occurs.

To cause a reliable adjustment of the illumination device 20 a sucking device is intended to build a connection with the illumination device 20. Through a corresponding movement of the sucking device an adjustment of the illumination device 20 is conceivable in a simple way.

The activation of the transformation of states of the adhesive element 40 is also conceivable via internal means, illustrated in FIGS. 10a and 10b. As can be seen the adhesive element 40 comprises a first 41 and a second chamber 42. The first chamber 41 contains a first component of the adhesive and in the second chamber 42 contains a second component of the adhesive. The chambers 41, 42 are separated by a flexible barrier 43, being in its resting position, as shown in FIG. 10a. If the illumination device has achieved its final mounting position the workman can reach the zone of engagement 44 at the barrier 43 from the outside and therewith convert the barrier 43 in its active state. Consequently the chambers 41, 42 are able to interact whereby a mixture of both components of the adhesive occurs and a curing procedure of the adhesive mixture is initiated. Therewith also a fixation of the illumination device at the assembly carrier is achieved in a reliable way.

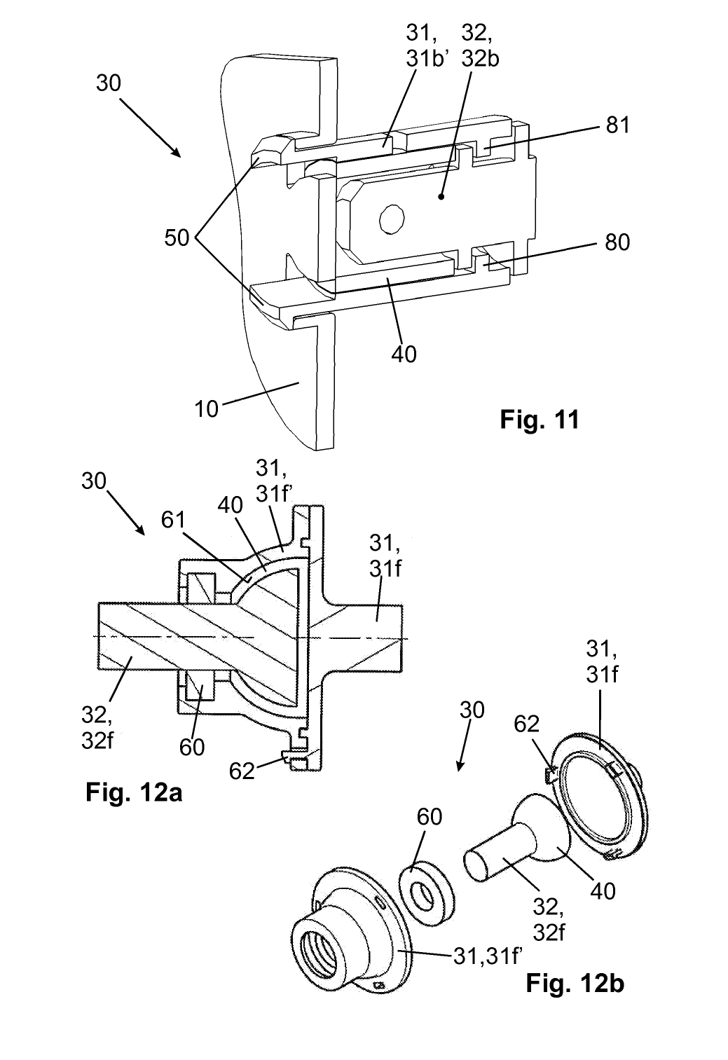

FIG. 11 is showing another embodiment of the holding device 30. Therein the first receiving composition 31 is formed as a casing 31b′ and the second receiving composition 32 as a cylinder element 32b, whereby the cylinder element 32b extends itself into the casing 31b′. The adhesive element 40 is shaped as a hollow cylinder and is assembled between the casing 31b′ and the cylinder element 32b. The casing 31b′ is clipsed to the first joining partner 10 via a clips connection 50 whereby the adhesive element 40 is arranged between the casing 31b′ and the cylinder element 32b in a way that the adhesive member 40 can be assembled in the casing 31b′ preliminary to the establishment of the clips connection 50 and is arranged in a loss-proofed way, in particular in the first state of the adhesive element 40, after the establishment of the clips connection 50 within the casing 31b′.

Alternatively, the casing 31b′ can also be assembled at the second joining partner 20. Both the cylinder element 32b and the casing 31b′ comprise a collar 81, 82 to prevent a leakage of material of the adhesive element 40 independently of its state.

FIG. 12a shows in a sliced, 2-dimensional view and FIG. 12b shows in a non-mounted perspective view another embodiment of the holding device 30 in which the first receiving composition 31 is formed as a flange 31f with a counter piece 31f′ and the second receiving composition 32 as a mushroom-like inner section 32f. The counter piece 31f′ comprises a half-shell like receiving area 61 in which the mushroom-like inner section 32f is acceptable. Further resting means 62 are illustrated which are assembled at the peripheral side of the flange 32f whereby the counter piece 31f′ is clipsable to the flange 31f via resting means 62. The adhesive element 40 is adjusted within the half-shell like receiving section 61 as the adhesive element 40 matches with the half-shell like form. In order to prevent a leakage of the adhesive element 40 in its viscous, first state, a sealing element 60 is intended enclosing the mushroom-like inner section 32f in the area of the outlet port out of the counter piece 31f′. The adhesive element 40 is glued to the flange 31f as well as to the counter piece 31f′ if the adhesive element 40 is transformed from its first to its second state. Hence, no substantial requirements are demanded from the rigidity of the resting means 62. The rigidity of the resting means 62 solely need to be sufficient to keep the counter piece 31f′ at the flange 31f during the adjustment in the first state of the adhesive element 40.

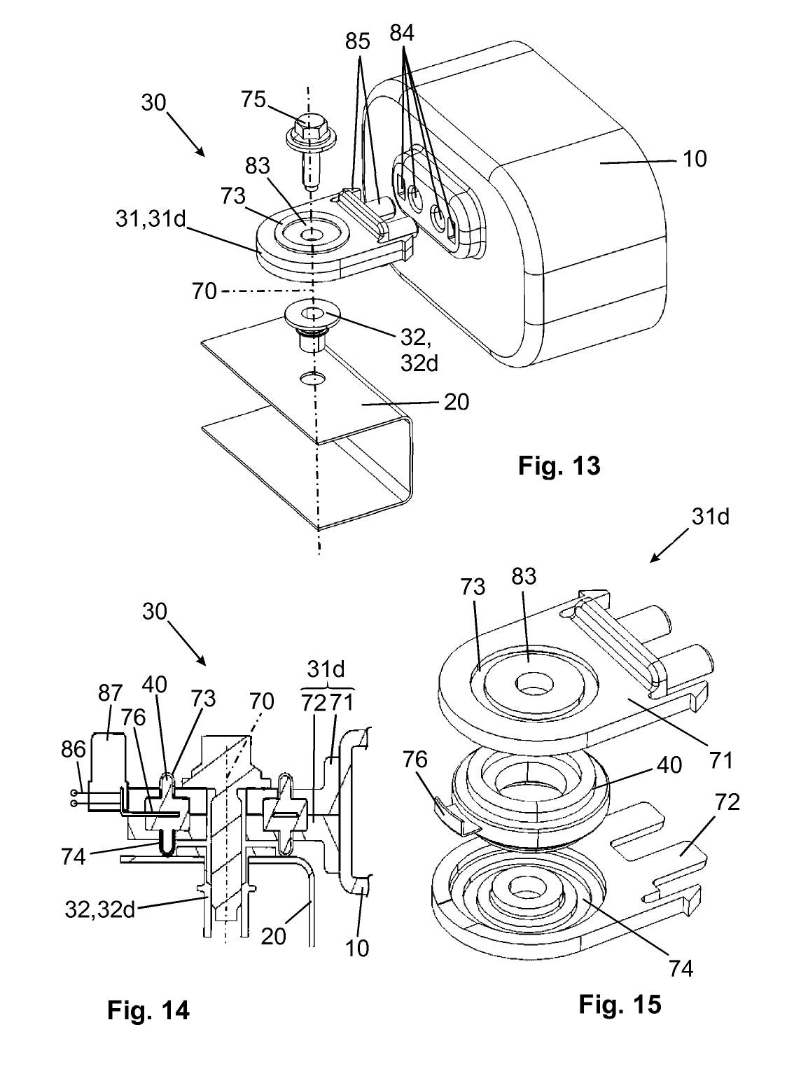

FIGS. 13, 14 and 15 show another embodiment of the shape of the holding device 30. The first receiving composition 31 is accomplished as a mounting clip 31d extending in a mounting clip level. The second receiving composition 32 is further formed as a mounting sleeve 32d which extends through the mounting clip 31d along an axis of casing 70. For connecting the mounting sleeve 32d to the second joining partner 20 a connecting element 75 formed as a screw is insertable into the mounting sleeve 32d. The axis of casing 70 is constituting a surface normal to the mounting clip level whereby the axis of casing 70 is forcing through the inner part 83 which is forming a rigid connection with the mounting sleeve 32d(?) if the connecting element 75 is inserted into the mounting sleeve 32d.

The mounting sleeve 32d can be shaped e.g. as an expanding sleeve which is forming a rigid composition with both the inner part 83 and the second joining partner 20 via expansion.

According to the illustration in FIG. 13 the first joining partner is comprising a clips arrangement 84 so that the mounting clip 31d is clapsable to the clips arrangement 84 via a notch arrangement 85. The notch arrangement 85 is comprising two cylinder elements 32b(?) and two engagement hooks via which the mounting sleeve 32d can form a rigid connection to the clips arrangement 84 at the first joining partner 20.

FIGS. 14 and 15 illustrate that the mounting sleeve 31d is formed of an upper component of a clips 71 and a lower component of a clips 72 forming a cavity in which the upper component of a clips 71 and the lower component of a clips 72 are assembled against one another. Hence, an adhesive element 40 can be adjusted in this cavity whereby a sealing element 73 is assembled in the upper component of a clips 71 and another sealing element 74 is assembled to the lower compartment of a clips 72. The mounting clip 31d forms, together with the inner part 83 and the sealing element 73, 74, an enclosed cavity in which the preferably viscous adhesive element 40 can be assembled in a lock-proof and particularly in a leak-proof way. The upper component of a clip 71 and the lower component of a clip 72 can be snapped, clipsed, welded or e.g. glued to one another upon inserting the adhesive element 40 to the cavity build at the inner surface.

In the shown embodiment a heating element 76 is intended which is e.g. assembled or rather inserted in the adhesive element 40. The heating element 76 is formed to heat the adhesive element 40 in a way that the heating element 76 is forming a or the means to transform the adhesive element 40 from its first to its second state. The heating element can be formed as an electric heating element 76, like illustrated in FIGS. 14 and 15, and an electrical connection 86 is shown via which an electric current can conduct trough the heating element 76 and which can be removed via a handle element 87 after heating.

The heating element 76 can be formed as a resistance wire or out of a flat stock comprising an electrical resistance, which is heating up if a current is applied using the electrical connection 86. The adhesive element is heated up by the released heat by what means according to the invention are built for transforming the adhesive element 40 from its first to its second state.

The illustrated heating element 76 is suitable in every embodiment of the adhesive element 40 according to every other embodiment according of the invention, as the assembly of the heating element 76 in the illustrated embodiment of the holding device 30 according to FIGS. 13, 14 and 15 is solely exemplary and can be implemented in every other potential embodiment of the present invention in this or a similar manner. Particularly, the cavity in which the adhesive element 40 is incorporated is able to accomplish the heating element 76 at the same time as this is solely adjacent to the adhesive element 40 whereby heat is inserted into the adhesive element 40 in the same manner based on heat conduction.

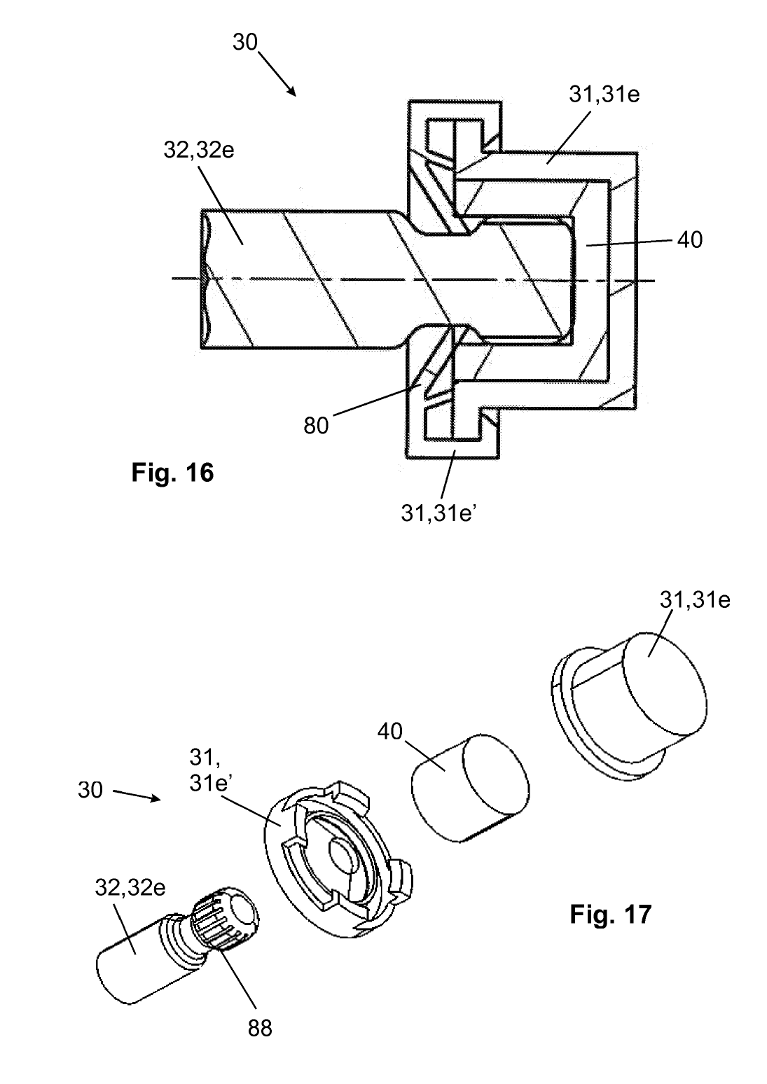

FIGS. 16 and 17 illustrate the last embodiment for shaping the holding device 30. According to this embodiment the first receiving composition 31 is forming a bowl-like body 31e with a counter piece 31e′. The second receiving composition 32 is built as a cylindrical inner section 32e extending itself into the bowl-like body 31e. The adhesive element 40 is in a hollow cylindrical shape assembled between the bowl-like body 31e and the cylindrical inner section 32e. For mounting the holding device 30 the adhesive element 40 is initially assembled into the bowl-like body 31e and subsequently the cylindrical inner section 32e is assembled at the inner surface of the adhesive element 40. Finally, the counter piece 31e′ is mounted to the bowl-like body 31e via a e.g. a clips connection (50?) or a bayonet connection whereby the counter piece 31e′ is comprising a sealing structure 80 which is sealing the cavity between the bowl-like body 31e and the cylindrical inner section 32e to accept the adhesive element 40 between the bowl-like body 31e and the cylindrical inner section 32e in a leak-proof manner. The cylindrical inner section 32e is further showing a head piece with a knurling 88 to establish a force closure of the cylindrical inner section 32e within the adhesive element 40.

The invention is not limited to the embodiments described above. More preferably a variety of options is conceivable which exercise the represented solutions in generally different embodiments. Any characteristic and/or advantage mentioned in the claims, the description or the figures, including structural details, spatial arrangements and procedural steps, are substantial for the invention either among themselves or in any combination.

1. Joining arrangement to join joining partners of a vehicle comprising:
a first joining partner;
at least a second joining partner;
a holding device, by which the joining partners are connectable to one another to form a joining arrangement,
wherein the holding device comprises a receiving composition, at which at least one adhesive element is assembled, where the adhesive element is capable of at least two states,
wherein in a first state the adhesive element enables an adjustment of the second joining partner at the first joining partner, and
wherein via a transformation means, the adhesive element is transformed from the first state to the second state,
wherein in the second state the adhesive element is cured, such that a fixation of the joining partners to one another is achieved.

2. Joining arrangement according to claim 1, wherein the transformation means are external electrical means configured to deliver thermal energy into the adhesive element.

3. Joining arrangement according to claim 1, wherein the adhesive element is adjusted to a geometry of the receiving composition, where the receiving composition delimits a cavity in which the cavity adjusted adhesive element is incorporated, whereby the adhesive element is viscous in its first state.

4. Joining arrangement according to claim 1, wherein the adhesive element comprises a reactive Hotmelt, and/or an encapsulated polyurethan and/or an epoxide adhesive and/or acrylate adhesives.

5. Joining arrangement according to claim 1, wherein the receiving composition is composed of multiple components, comprising a first part of the receiving composition is arranged at the first joining partner and a second part of the receiving composition arranged at the second joining partner and/or the receiving composition is integrally formed.

6. Joining arrangement according to claim 1, wherein the adhesive element comprises at least two chambers, where the two chambers are form a cavity, whereby in the first chamber a first component of an adhesive is disposed and in the second chamber a second component of an adhesive is disposed.

7. Joining arrangement according to claim 6, further comprising a barrier element, sperating the chambers from one another while the adhesive element is in the inactivated state and is upon activation flexible to such an extent that a mixing of the first and the second component is possible, whereby the barrier element is flexibly mounted to the adhesive element and is activatable from the outside in a certain zone of engagement.

8. Joining arrangement according to claim 1, wherein the joining arrangement is formed for joining preventilated assembly groups of the vehicle comprising at least one of a front module, a rear end module, a hatch door, a door module a bumper, a cover of a bumper at a carriage of the vehicle, an illumination device with or at an assembly carrier, and a cockpit device of the vehicle.

9. Joining arrangement according to claim 5, wherein the first part of the receiving composition is an opening and/or the second part of the receiving composition is formed as a rod-shaped element, wherein the opening adjusts the adhesive element shaped as cylindrical body and/or wherein the adhesive element encloses the rod-shaped element, so that the rod-shaped element extends into the opening.

10. Joining arrangement according to claim 5, wherein the second receiving composition is formed in a T-like manner, whereby the rod-shaped element comprises two ends opposite to one another, wherein both ends possess a first receiving composition respectively, and wherein the holding device is attached to the assembly carrier by a form- and/or force-closure and wherein the rod-shaped element comprises a clear end only at one side, at which the first receiving composition is attachable.

11. Joining arrangement according to claim 5, wherein the first receiving composition is formed as a casing and/or the second receiving composition is shaped as a cylinder element, wherein the cylinder element extends into the casing and wherein the adhesive element is preferably in shape of a hollow cylinder and is arranged between the casing and the cylinder element.

12. Joining arrangement according to claim 11, wherein the casing is clipsable to the first joining partner via a clips connection, wherein the adhesive element is preferably arranged between the casing and the cylinder element in a way that the adhesive member is assembled in the casing preliminary to the establishment of the clips connection and is arranged in a loss-proofed way, in the first state of the adhesive element, after the establishment of the clips connection in the casing.

13. Joining arrangement according to claim 1, wherein the first receiving composition is formed as a flange with a counter piece and/or the second receiving composition is formed as a mushroom-like inner section, wherein the counter piece comprises a half-shell like receiving area in which the mushroom-like inner section is incorporated.

14. Joining arrangement according to claim 13, further comprising resting means wherein the counter piece is locked with the flange through the resting means and wherein the adhesive element is incorporated in the half-shell like receiving area, the joining arrangement further comprising a sealing element which encloses the mushroom-like inner section within a range of an outlet port of the counter piece.

15. Joining arrangement according to claim 1, wherein the first receiving composition comprises a mounting clip extending in a mounting clip level, wherein the second receiving composition is preferably formed as a mounting sleeve which extends through the mounting clip along an axis of casing and which is inserted into a connecting element, wherein the axis of casing is representing a surface normal to the mounting clip level.

16. Joining arrangement according to claim 15, wherein the mounting clip comprises an upper and a lower compartment of clips, which are placed against one another to build a cavity, so that the adhesive element is receivable in the cavity, wherein in the upper compartment of clips and in the lower compartment of clips a sealing element is disposed and wherein the mounting clips are clipsable to the first joining partner.

17. Joining arrangement according to claim 1, wherein the first receiving composition is formed as a bowl-like body with a counter piece and the second receiving composition is formed as a cylindrical inner section which extends into the bowl-like body and wherein the adhesive element is assembled between the bowl-like body and the cylindrical inner section wherein the counter piece comprises a sealing structure.

18. Joining arrangement according to claim 3, further comprising a heating-element arranged at and/or in the adhesive element or at least at the cavity and which is configured to heat the adhesive element such that the heating-element activates the transformation from the first to the second state of the adhesive element.

19. Joining arrangement according to claim 1, wherein the first joining partner comprises an assembly carrier for an illumination device of the vehicle and the second joining partner comprises an illumination device of the vehicle, wherein the holding device comprises a receiving composition at which said at least one adhesive element is assembled which is transformable into said at least two states, wherein in the first state the adhesive element enables an adjustment of the illumination device at the assembly carrier and via said transformation means the transformation from the first to the second state is activatable wherein the adhesive element is cured in the second state by which a fixation of the illumination device at the assembly carrier is achievable.

20.-24. (canceled)
